(19) United States
(12) Patent Application Publication
(10) Pub. No.: US 2009/0103619 A1
(43) Pub. Date: Apr. 23, 2009

(54) METHOD OF CODING AND DECODING MULTIVIEW SEQUENCE AND METHOD OF DISPLAYING THEREOF

(75) Inventors: Kwang Hoon Sohn, Seoul (KR); Jeong Sun Lim, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/571,235

(22) PCT Filed: Jun. 24, 2005
(86) PCT No.: PCT/KR2005/001969

§ 371 Date: Jan. 30, 2008

(30) Foreign Application Priority Data
Jun. 25, 2004 (KR) 10-2004-0048340

(51) Int. Cl. H04N 7/32; H04N 7/26

(52) U.S. Cl. 375/240.16; 375/240.26; 375/E07.243; 375/E07.123

(57) ABSTRACT

A method of coding/decoding a multiview sequence and display method thereof are disclosed, by which multiview sequence data can be efficiently coded and decoded. A multiview sequence coding method according to the present invention includes a step of generating a bit stream by encoding a plurality of pictures acquired from a plurality of views, wherein the bit stream includes view information for each of a plurality of the pictures and wherein the view information is information designating that the corresponding picture corresponds to which view among a plurality of the views. Accordingly, the multiview sequence is encoded to be selectively decoded for display.

### TECHNICAL FIELD

The present invention relates to a method of coding/decoding a multiview sequence, and more particularly, to a method of coding/decoding a multiview sequence and display method thereof. Although the present invention is suitable for a wide scope of applications, it is particularly suitable for performing coding/decoding on multiview sequence data and for enabling a view selection for decoding a moving picture corresponding to a view requested by a receiving end.

### BACKGROUND ART

Generally, the current media not only displays a simple text and a 2-dimensional video but also enables clear and vivid perception of an object or status through unified recognition of the five senses of vision, hearing, touch, smell and taste. The multimedia is combined with communications to be more important and meaningful. Attributed to the development of fast and massive information transport technology, multimedia communications of videophone, remote video conference, remote shopping and the like are enabled.

The multimedia technology will become more powerful if developing into a 3-dimensional signal processing. For this, the development of a 3-dimensional video processing and communication technology enabling the realistic and natural reproduction of a human life space is demanded.

Meanwhile, people live in a 3-dimensional world including the sense of depth as well as top, bottom, right and left senses. Hence, many attentions are paid to a 3-dimensional stereoscopic image for the cubic effect and the sense of the real by which people can experience the sense of depth as well as a 2-dimensional video that provides a feeling of two dimensions. And, the 3-dimensional video processing technology is currently applied to various fields of communications, broadcasting, virtual reality, education, medical care, entertainment, etc.

The simplest way of representing three dimensions with a 2-dimensional image is a stereo method. A stereo image, which is configured with right and left images, is disadvantageous in its massive volume of data. So, the stereo image needs a vast storage device, a network and a fast computer system. And, if the stereo image is independently encoded, a bandwidth about twice greater than that for a 2-dimensional image transport is required for the stereo image. In case of a stereo sequence resulting from extending the stereo image on a time axis or a multiview sequence resulting from extending the stereo image on time and view axes, a data volume massively increases in proportion to a view number and a required bandwidth is raised as well.

As more intentions are paid to the 3-dimensional image, many efforts are made to research and develop a 3-dimensional video compression and reproduction display system by various instruments, universities, labs and the like.

A receiving end of such a 3-dimensional video system needs a 3-dimensional display that can decode and display a multiview sequence. A currently developed 3-dimensional LCD (liquid crystal display) monitor provides a cubic effect to one observer and is evolving into a 3-dimensional multiview display monitor that can provide the cubic effect and the sense of the real to several observers.

However, since a data volume and operational quantity of the 3-dimensional multiview sequence are increased according to the increments of the view number, a multiview coder/decoder (CODEC) that can efficiently perform coding and decoding on the 3-dimensional multiview sequence is needed. And, it is also needed to decode a specific view only in a receiving end according to a user's display.

### DISCLOSURE OF THE INVENTION

Accordingly, the present invention is directed to a method of coding/decoding a multiview sequence and display method thereof that substantially obviate one or more of the problems due to limitations and disadvantages of the related art.

An object of the present invention is to provide a method of coding/decoding a multiview sequence and display method thereof, by which multiview sequence data can be efficiently coded and decoded.

Another object of the present invention is to provide an apparatus for decoding data coded into a multiview sequence efficiently and display method using the same.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a multiview sequence coding method according to the present invention includes the step of generating a bit stream by encoding a plurality of pictures acquired from a plurality of views, wherein the bit stream includes view information for each of a plurality of the pictures and wherein the view information is information designating that the corresponding picture corresponds to which view among a plurality of the views.

To further achieve these and other advantages and in accordance with the purpose of the present invention, a multiview sequence coding method includes the steps of generating a main bit stream by encoding pictures of a first picture type for a main view and generating an auxiliary bit stream for at least one or more auxiliary views wherein the auxiliary bit stream is generated by encoding pictures of a second picture type predicted using the pictures of the first picture type, wherein the auxiliary bit stream includes view information for each of the pictures of the second picture type and wherein the view information is information designating that the corresponding picture of the second picture type corresponds to which auxiliary view among the at least one or more auxiliary views.

To further achieve these and other advantages and in accordance with the purpose of the present invention, a multiview sequence decoding method includes the steps of receiving a main bit stream generated by encoding pictures acquired from a plurality of views, respectively, checking view information designating that a specific picture corresponds to which one of a plurality of the views, and decoding the picture associated with the specific view in a display according to the checked view information.

To further achieve these and other advantages and in accordance with the purpose of the present invention, a multiview sequence decoding method includes the steps of receiving a main bit stream generated by encoding pictures acquired from a main view and an auxiliary bit stream generated by encoding pictures acquired from a plurality of auxiliary views, restoring the pictures within the main bit stream, and selectively performing predictive restoration on the picture associated with a specific auxiliary view in a display by utilizing the restored pictures within the main bit stream according to view information existing within the auxiliary bit stream.

To further achieve these and other advantages and in accordance with the purpose of the present invention, a multiview sequence decoding apparatus includes a main bit stream decoding unit receiving a main bit stream generated by encoding pictures acquired from a main view to restore the pictures within the main bit stream and an auxiliary bit stream decoding unit receiving an auxiliary bit stream generated by encoding pictures acquired from a plurality of auxiliary views, the auxiliary bit stream decoding unit selectively performing predictive restoration on the pictures of a specific auxiliary view by utilizing the restored pictures within the main bit stream according to view information existing within the auxiliary bit stream.

To further achieve these and other advantages and in accordance with the purpose of the present invention, a multiview sequence display method includes a first display mode displaying pictures corresponding to a main view and a second display mode displaying the pictures corresponding to the main view and pictures corresponding to at least one or more auxiliary views together, wherein either the first display mode or the second display mode is selected according to view information existing within a bit stream including the pictures.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of a multiview sequence coding apparatus applicable to the present invention;

FIG. 2 is a diagram of an example of an auxiliary bit stream generated according to the present invention;

FIGS. 3A to 3C are diagrams of one embodiment of ‘GGOP’ for coding a 5-view sequence according to the present invention;

FIG. 4A and FIG. 4B are diagrams of one embodiment of ‘GGOP’ for coding a 9-view sequence according to the present invention;

FIG. 5 is a schematic diagram for explaining a concept of a multiview sequence display method according to one embodiment of the present invention;

FIG. 6 is a diagram of a bit stream for explaining header information transferred for decoding according to the present invention;

FIG. 7 is a block diagram of a multiview sequence decoding apparatus according to the present invention;

FIGS. 8A to 8E are diagrams of a multiview sequence for explaining a coding/decoding method according to the present invention;

FIGS. 9A to 9E are diagrams of a multiview sequence for explaining a coding/decoding method according to the present invention;

FIG. 10 is a graph for explaining a coding result at various bit rates of a 5-view sequence in FIGS. 8A to 8E;

FIG. 11A and FIG. 11B are graphs for explaining a coding result at various bit rates of a sequence in FIG. 9A;

FIG. 12A and FIG. 12B are exemplary diagrams of image comparison in case of coding an image having a big base line by ‘One-I’ type and ‘Two-I’ type, respectively;

FIG. 13A and FIG. 13B are diagrams of result images for explaining performance of a B_{t,s} frame of the present invention; and

FIGS. 14A to 14D are diagram of result images if second and fourth views are selected by a user having received a 5-view bit stream in FIGS. 9A to 9E in case of a 3-dimensional monitor, which can display a stereo sequence only, is provided to a receiving end.

### BEST MODE FOR CARRYING OUT THE INVENTION

Reference will now be made in detail to the preferred embodiments of the present invention, examples of which are illustrated in the accompanying drawings.

Besides, although terms used in the present invention are possibly selected from the currently well-known ones, some terms are arbitrarily chosen by the applicant in some cases so that their meanings are explained in detail in the following description. Hence, the present invention should be understood with the intended meanings of the corresponding terms chosen by the applicant instead of the simple names or meanings of the terms themselves.

First of all, ‘multiview sequence’ used in the present invention means that moving pictures differing in view point for a same subject are simultaneously acquired at the same time. For instance, the ‘multiview sequence’ means a moving picture acquired from photographing a same subject at various angles and in various directions by means of a plurality of moving picture capturing instruments (e.g., cameras).

Specifically, ‘main view’ in the present invention means a view that is a reference of coding among the multiview. A moving picture corresponding to the ‘main view’ is coded into a bit stream by a conventional moving picture coding scheme such as MPEG-2, MPEG-4, H.623, H-264, etc. And, the bit stream is called ‘main bit stream’ in the present invention. For convenience of explanation, MPEG-2 is taken as an example of the conventional moving picture coding scheme, on which the present invention put limitation.

And, ‘auxiliary view’ in the present invention means a view that is not the main view among the multiview. A moving picture corresponding to the ‘auxiliary view’ is coded into a bit stream by a unique coding scheme of the present invention that will be explained later. And, this bit stream is called ‘auxiliary bit stream’ in the present invention.

Moreover, it is intended in the present invention that ‘bit stream’ is inclusively used as the ‘main stream’ or ‘auxiliary stream’.

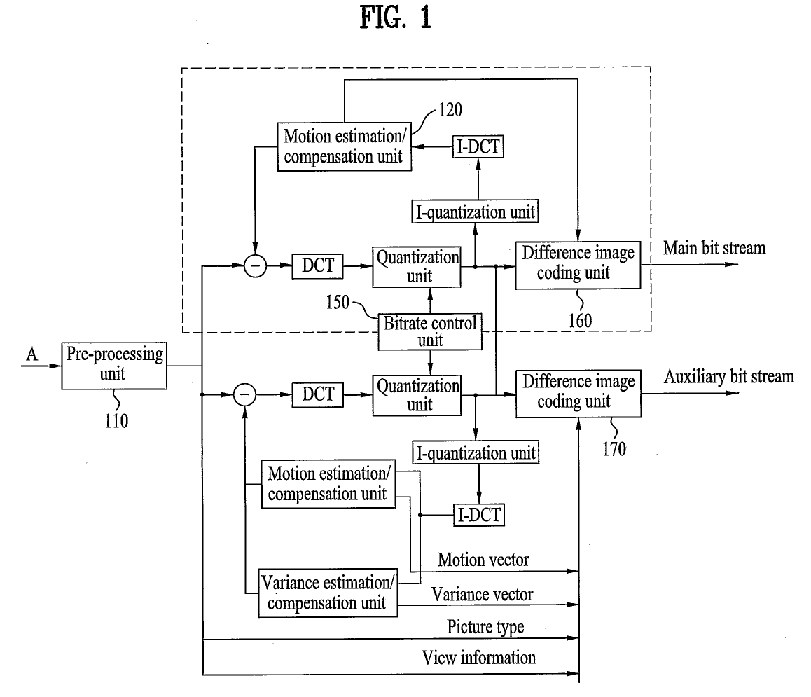

FIG. 1 is a block diagram of a multiview sequence coding apparatus applicable to the present invention.

In a coding method according to the present invention, a sequence taken as a reference for compatibility with MPEG-2 is encoded by an MPEG-2 encoder to generate a main bit stream and an auxiliary bit stream is generated from auxiliary view sequences. Namely, the main bit stream includes data for the sequence including an ‘I (explained later)’ picture and the auxiliary bit stream includes various kinds of information encoded by variance estimation and motion estimation of other sequences.

Referring to FIG. 1, a multiview coding apparatus applicable to the present invention includes a pre-processing unit 110, motion estimation/compensation units 120 and 130, a variance estimation/compensation unit 140, a bit rate control unit 150 and difference image coding units 160 and 170.

If a multiview sequence data A is inputted, the pre-processing unit 110 removes a noise, solves an imbalancing problem, increases reliance of vectors resulting from variance estimation and motion estimation by raising correlation between the multiview sequence data through a pre-processing, and then provides the pre-processed data to the variance estimation/compensation unit 140, the motion estimation/compensation units 120 and 130 and the difference image coding units 160 and 170.

In doing so, the imbalancing problem can be solved in a manner of compensating the imbalancing using an average and distribution of a reference image and a compensation image to be compensated and removing a noise simply using a median filter.

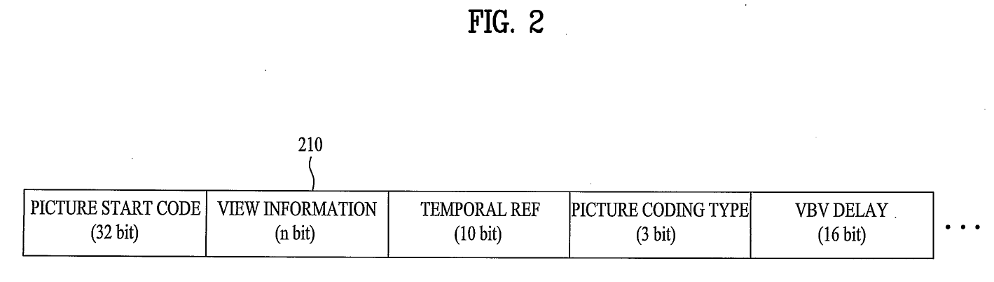

The pre-processing unit 110 inserts ‘view information’ in the auxiliary bit stream to provide information to restore a specific view in a decoder, which is explained in FIG. 2.

The variance estimation/compensation unit 140 and the motion estimation/compensation units 120 and 120 estimate a variable vector and a motion vector by taking a sequence axis including the ‘I’ picture and compensate them using half-pel compensation.

The difference image coding units 160 and 170 can generate the bit stream for the provided multiview sequence in a manner of carrying out coding on difference information between an original image provided from the pre-processing unit 110 and a restoration image compensated by the variance estimation/compensation unit 140 and the motion estimation/compensation units 120 and 130 to provide enhanced image quality and cubic effect.

And, the bit rate control unit 150 can control a bit rate for allocating bits to each picture efficiently.

FIG. 2 is a diagram of an example of an auxiliary bit stream generated according to the present invention.

Referring to FIG. 2, ‘view information’ 210 inserted according to the present invention can be inserted with n-bits in a picture header within an auxiliary bit stream for example. In doing so, n-bits are to consider a case of supporting maximum 2ⁿ views.

Namely, the ‘view information’ is utilized as information designating that a specific picture corresponds to which auxiliary view among a plurality of auxiliary views. Hence, in case that pictures for a plurality of views are mixed within one auxiliary bit stream, the ‘view information’ is needed to selectively restore pictures associated with the specific view only.

Yet, the ‘view information’ is not limited to the auxiliary bit stream only but can be utilized in meaning a picture associated with a specific view regardless of the distinction between the main bit stream and the auxiliary bit stream.

A specific method of performing multiview sequence coding according to the present invention is explained in detail as follows.

In a general coding scheme, e.g., MPEG-2 coding scheme, a basic unit of coding is GOP (group of pictures). And, the GOP (group of pictures) includes an ‘I’ picture, a ‘P’ picture and a ‘B’ picture.

The ‘I’ picture is for performing intra coding and enables a random access to a sequence. The ‘P’ picture estimates a motion vector in a mono-direction by taking the previously coded ‘I’ or ‘P’ picture as a reference image. And, the ‘B’ picture estimates a motion vector in bi-directions using the ‘I’ and ‘P’ pictures. A length of GOP, i.e., ‘N’ means a distance between the ‘I’ pictures and ‘M’ means a distance between the ‘I’ and ‘P’ pictures.

Yet, the ‘I’ picture, ‘P’ picture’ and ‘B’ picture are picture terms used in the MPEG-2 coding scheme. If the coding schemes are different from each other, usable terms will differ from each other. For instance, in a main bit stream follows a scheme different MPEG2, a picture that is decodable without referring to any reference picture is named ‘L’ picture. And, a picture decodable with reference to at least one or two reference pictures is called ‘H’ picture.

To encode a multiview sequence, the present invention proposes a ‘GGOP (group of GOP)’ structure that is a basic unit of multiview sequence coding.

‘GGOP’ of the present invention includes pictures corresponding to a time axis and a view axis unlike the ‘GOP’ of MPEG-2. Namely, by removing correlation on a space, correlation on a time axis and correlation between views using the ‘GGOP’ structure, the multiview sequence can be efficiently coded.

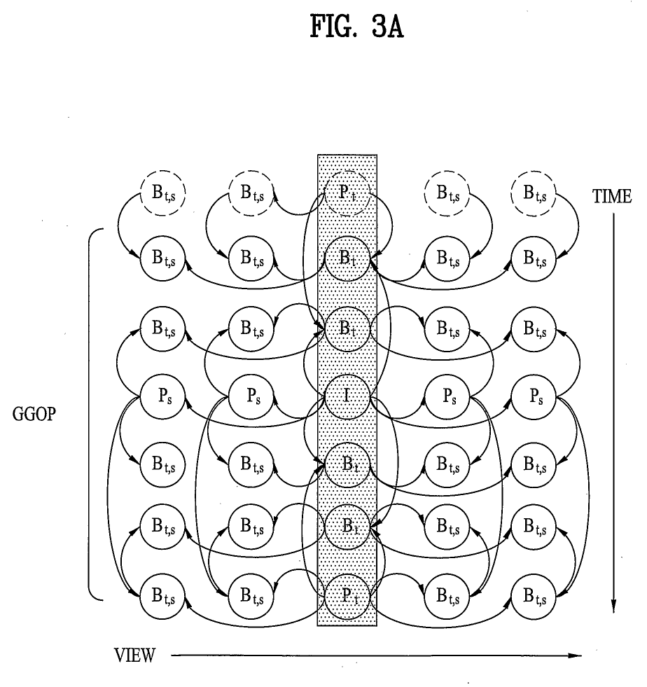

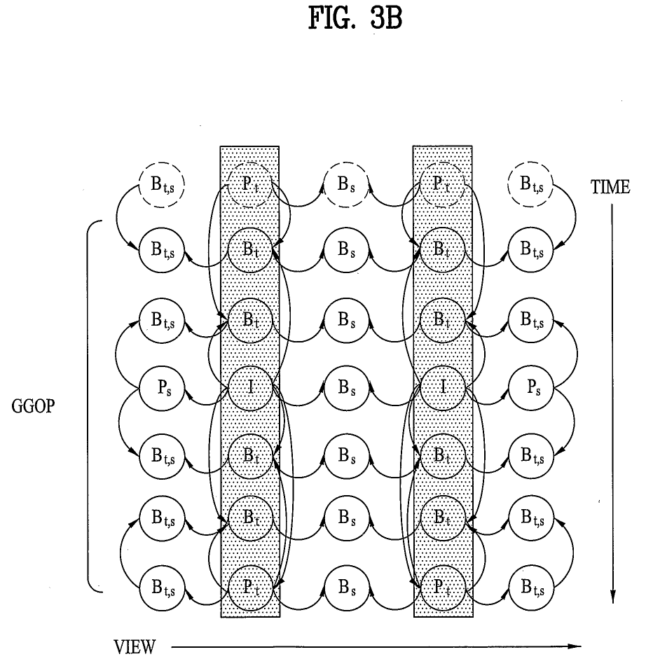

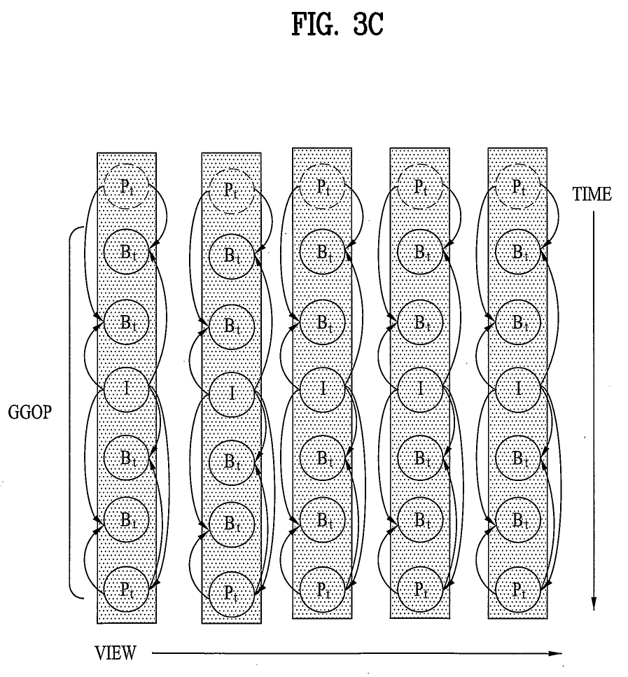

FIGS. 3A to 3C are diagrams of one embodiment of ‘GGOP’ for coding a 5-view sequence according to the present invention, in which ‘One-I’ type (FIG. 3A), ‘Two-I’ type (FIG. 3B) and ‘Five-I’ type (FIG. 3C) are shown. For convenience of explanation, a case of ‘N=6 and M=3’ is taken as an example. And, it is apparent to those skilled in the art that the present invention is not limited to the case of ‘N=6 and M=3’.

Referring to FIG. 3A, a ‘One-I’ type of the ‘GGOP’ structure of the present invention includes one ‘I’ picture, one ‘Pₜ’ picture, four ‘Pₜ’ pictures, four ‘Pₛ’ pictures and twenty ‘B_{t,s}’ pictures.

In this case, the ‘Pₜ’ picture is the picture type that estimates the motion vector in a mono-direction like the ‘P’ picture used in MPEG-2 and the ‘Bₜ’ picture is the picture type that estimates the motion vector in bi-directions like the ‘B’ picture used in MPEG-2. In the present invention, the ‘I’ picture, ‘Pₜ’ picture and ‘Bₜ’ picture are named first type pictures configuring a main bit stream.

The ‘Pₛ’ picture is an image restored using correlation between views, i.e., variance estimation. And, the ‘B_{t,s}’ picture means an image restored using a motion vector on a temporal axis and a variance vector on a view axis or by interpolation between two vectors.

In the ‘One-I’ type in case of ‘N=3 and M=3’ like FIG. 3A, a sequence taken as a reference, i.e., one sequence to be coded by MPEG-2 is included. In this case, arrows mean directions for estimating the variance vector and the motion vector.

‘ . . . Bₜ, Bₜ, I, Bₜ, Bₜ, Pₜ, . . . ’, which is a main view sequence including ;I’ picture therein, is encoded by an MPEG-2 encoder for compatibility with MPEG-2. And, it is also possible to set the generated bit stream to be equal to a syntax of MPEG-2. As mentioned in the foregoing description, a bit stream corresponding to a main sequence is defined as a main bit stream and data of a sequence corresponding an auxiliary view is defined as an auxiliary bit stream. Hence, in case of the 50view ‘One-I’ type like FIG. 3A, it is able to generate one main bit stream and one auxiliary bit stream.

In case that an interval between cameras in acquiring a multiview sequence is considerable, i.e., if a baseline is big, an error between views can be increased. Hence, if there exists only one sequence taken as a reference, the image quality of sequences corresponding to a view axis far from a main view may be degraded. So, it is preferable that at least two main sequences are needed to encode the multiview sequence acquired from a multiview camera having a big baseline.

In case that a multiview is designated according to a camera photographing angle, a camera photographing angle difference between cameras becomes the baseline. And, it is also preferable that at least two main sequences are set in case that the camera photographing angle difference is big.

FIG. 3B shows a 50view ‘Two-I’ type that is proposed to encode a multiview sequence acquired from a multiview camera having a big baseline. In this case, a multiview sequence encoder can generate two main bit streams and one auxiliary bit stream.

A ‘Bₛ’ picture at a third view means a picture type restored using variances estimated from right and left images neighboring to each other or by interpolation of two variances.

In the present invention, the ‘Pₛ’ picture, ‘Bₛ’ picture and ‘B_{t,s}’ picture are named second type pictures configuring an auxiliary bit stream.

Meanwhile, the ‘Five-I’ type in FIG. 3C means a case that a multiview sequence is regarded as an MPEG-2 sequence to be independently encoded without performing variance estimation. In this case, five main bit streams are generated. And, an auxiliary bit stream is not generated since variance estimation is not performed.

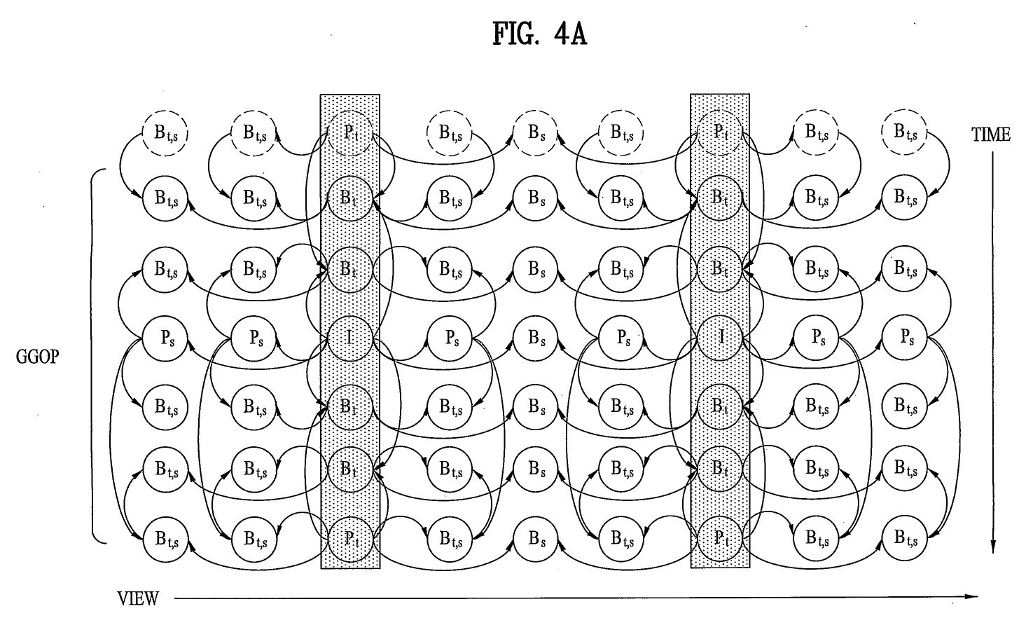

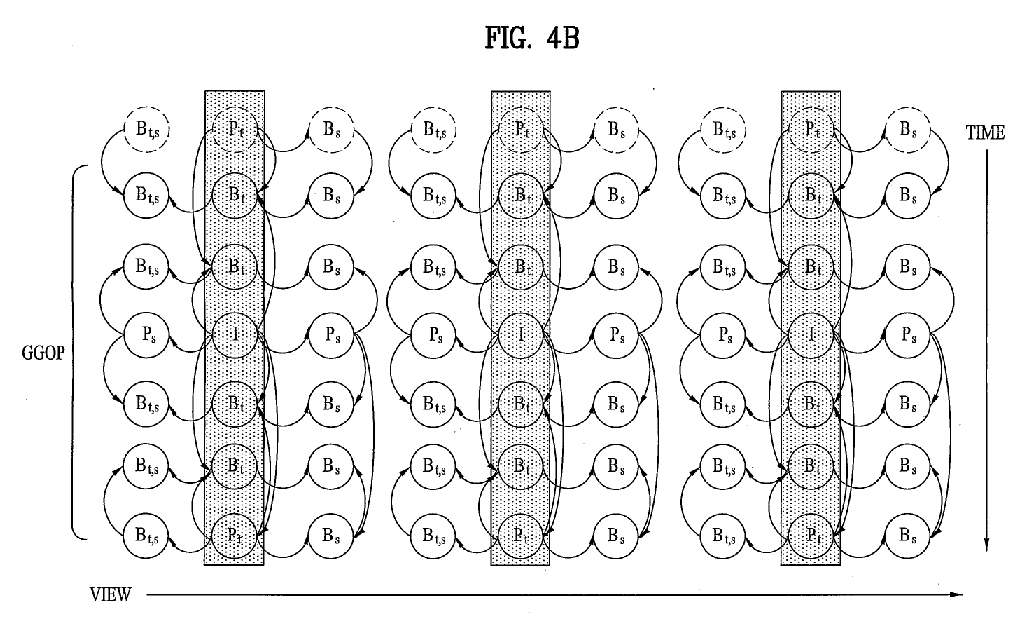

In one embodiment of the present invention explained through FIGS. 3A to 3C, the ‘GGOP’ structure corresponding to the 5-view sequence is taken as an example, which is extendible even if the number of views is raised. And, such an extendible example is explained with reference to FIG. 4A and FIG. 4B as follows.

FIG. 4A and FIG. 4B are diagrams of one embodiment of ‘GGOP’ for coding a 9-view sequence according to the present invention, in which ‘Two-I’ type and ‘Three-I’ type are shown, respectively. In this case, for compatibility with MPEG-2, a main sequence including ‘I’ picture therein is encoded by an MPEG-2 encoder to generate a main bit stream. Likewise, other auxiliary view sequences are generated into an auxiliary bit stream.

FIG. 4A shows the ‘GGOP’ structure for ‘Two-I’ type in case of ‘N=6 and M=3’. And, the ‘GGOP’ structure includes two ‘I’ pictures, two ‘Pₜ’ pictures, six ‘Pₛ’ pictures, six ‘Bₛ’ pictures and thirty-eight ‘B_{t,s}’ pictures.

FIG. 4B shows the ‘GGOP’ structure for a 9-view sequence acquired from a multiview camera in case of a big baseline. In this case, three main bit streams and one auxiliary bit stream are generated. Instead of using the variance estimation like the ‘Five-I’ type for the 5-view sequence in FIG. 3C, the sequence corresponding to each view can be individually encoded by the MPEG-2 encoder.

The present invention proposes a concept of enabling a restoration of a sequence corresponding to a specific view only by considering the characteristics of a display retained by a receiving end.

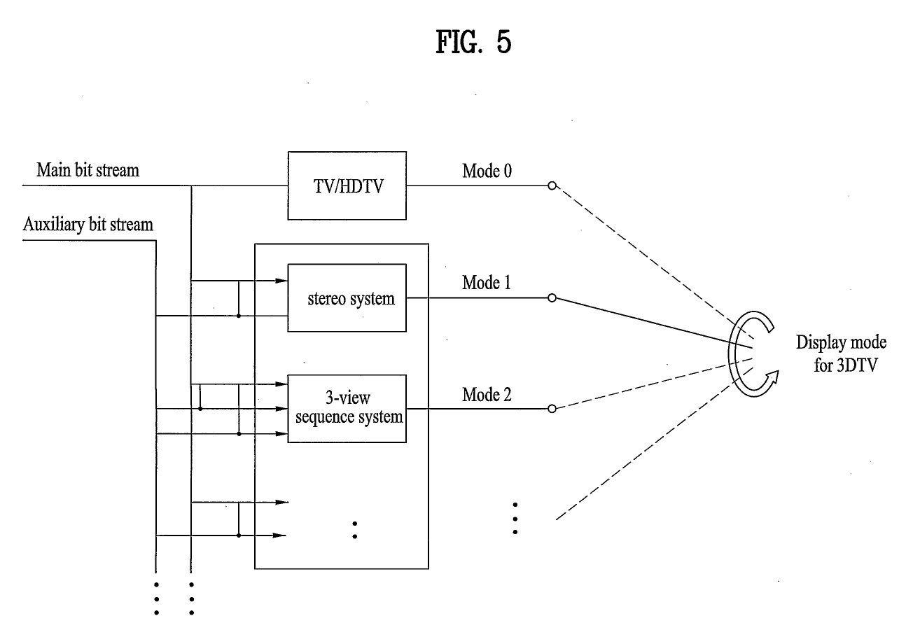

FIG. 5 is a schematic diagram for explaining a concept of a multiview sequence display method according to one embodiment of the present invention.

Referring to FIG. 5, in a display method according to the present invention, a received multiview sequence bit stream can be restored by selecting a specific view according to a type of a display retained by a receiving end.

For instance, when a transmitting end encodes a 5-view sequence and then transmits the encoded sequence to a receiving end, a user is unable to view a 3-view sequence as well as the 5-sequence view in case that the receiving end has a multiview monitor that can display the 3-view sequence only. This problem is caused since the transmitting end is not provided with information for a view in encoding a multiview sequence. Hence, the present invention intends to solve such a problem.

Namely, when a transmitting end encodes a 5-view sequence and then transmits the encoded sequence to a receiving end, a user selects three views from five views to enable a corresponding restoration in case that the receiving end has a 3-dimensional multiview monitor that can display the 3-view sequence only (Mode 2: this can be called ‘a second display mode’). And, the information enabling the selective restoration corresponds to the aforesaid ‘view information’.

In case that a receiving end has a monitor that can display a 2-dimensional sequence only instead of a multiview monitor, it is able to restore a main bit stream only to transfer to a display (Mode 0: this can be called ‘a first display mode’).

In particular, the display method according to the present invention is characterized in having a first display mode displaying pictures corresponding to a main view only and a second display mode displaying the pictures corresponding to the main view and other pictures corresponding to at least one auxiliary view and in that one of the display modes is selected to display according to view information existing within a bit stream including the pictures.

FIG. 6 is an exemplary diagram of a bit stream for explaining header information transferred for decoding according to the present invention.

Referring to FIG. 6, ‘view information’ is inserted in picture header information in generating multiview sequence bit streams so as to be provided as information that indicates a currently encoded picture is the data corresponding to what order in a plurality of views. The information for the view is set to n-bits that can support a sequence of 2ⁿ views.

Although FIG. 6 shows that the ‘view information’ is inserted in the auxiliary bit stream only, the ‘view information’ can be inserted in one side within the main bit stream according to a usage.

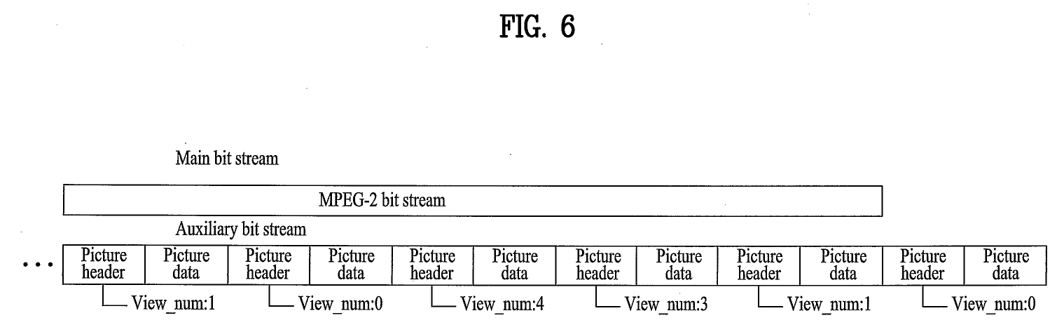

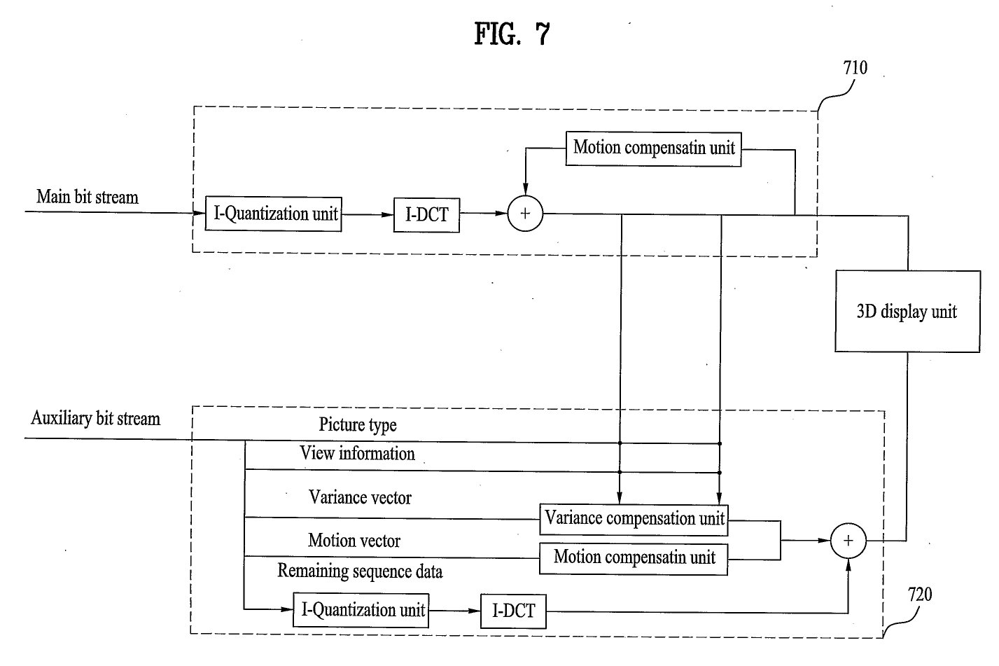

FIG. 7 is a block diagram of a multiview sequence decoding apparatus to which the present invention is applicable.

Referring to FIG. 7, a decoding apparatus, to which the present invention is applicable, includes a main bit stream decoding unit 710 and an auxiliary bit stream decoding unit 720.

The main bit stream decoding unit 710 carries out decoding by an MPEG-2 decoder and the auxiliary bit stream decoding unit 720 caries out decoding using variance and motion vectors. In doing so, to decode a specific view in a receiving end, it is checked what order of a view a currently decoded data has in a manner of confirming ‘view information’ from picture header information. Namely, since the specific view is restored in the present invention, it is able to reduce decoding time and a calculation load of the decoding unit.

In particular, the main bit stream decoding unit 710 receives a main bit stream generated by a main view and then restores pictures within the main bit stream.

And, the auxiliary bit stream decoding unit 720 receives an auxiliary bit stream generated by a plurality of auxiliary views and then selectively carries out predictive restoration on pictures of a specific auxiliary view according to the view information existing within the auxiliary bit stream by utilizing the picture within the main bit stream restored by the main bit stream decoding unit 710.

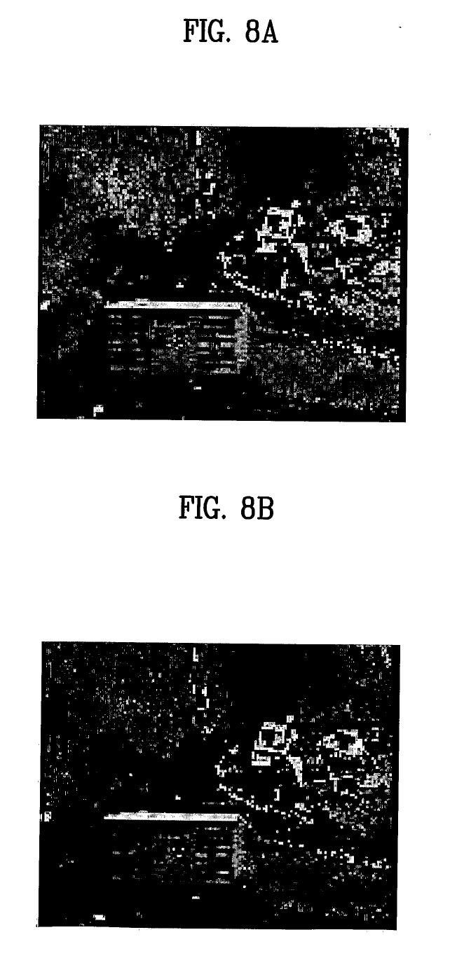

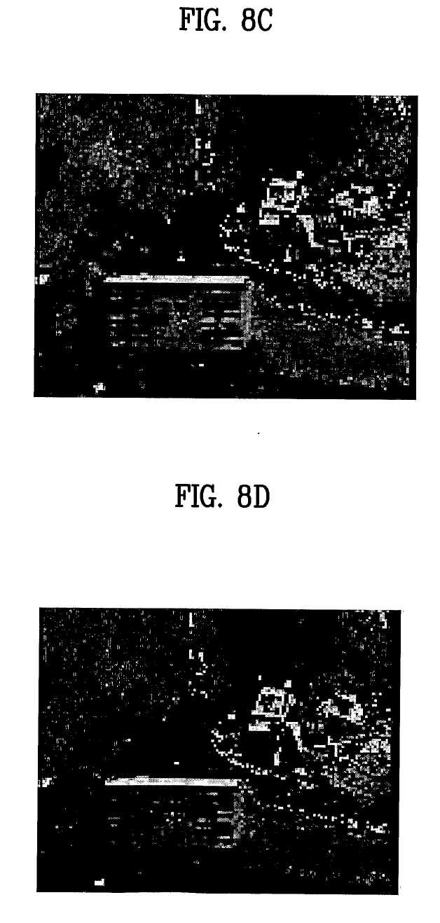

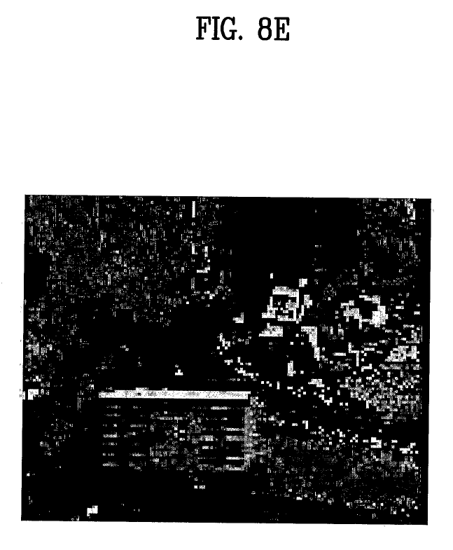

FIGS. 8A to 8E are exemplary diagrams of a multiview sequence for explaining a coding/decoding method according to the present invention, in which a 5-view case is shown.

An image size used in test is 720×576. A macroblock size is 16×16. a search range in x-direction for variance estimation is set to −16˜16. A search range in y-direction is not set since a parallel camera is assumed. For motion estimation, a search range in x-direction and y-direction is set to −16˜16. And, a video format used in test is set to Y:U:V=4:2:0.

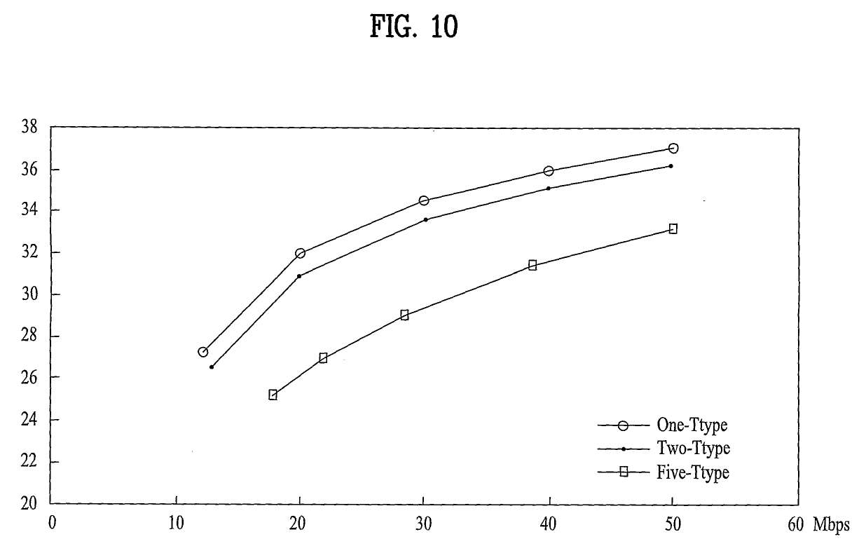

FIG. 10 is a graph for explaining a coding result at various bit rates of a 5-view sequence in FIGS. 8A to 8E.

Referring to FIG. 10, when ‘One-I’ type and ‘Two-I’ type are compared to ‘Five-I’ type with no variance estimation, it can be confirmed that good efficiency appears at a similar bit rate.

Meanwhile, as mentioned in the foregoing description, the present invention proposes the ‘GGOP’ structure of fluidity. Namely, by applying at least ‘Two-I’ type for compensating correlation between views to encoding of a multiview sequence having a big baseline and by applying ‘One-I’ type to a multiview sequence having a small baseline, more bits are allocated to the rest of picture types except ‘I’ frame in comparison to ‘Two-I’ type.

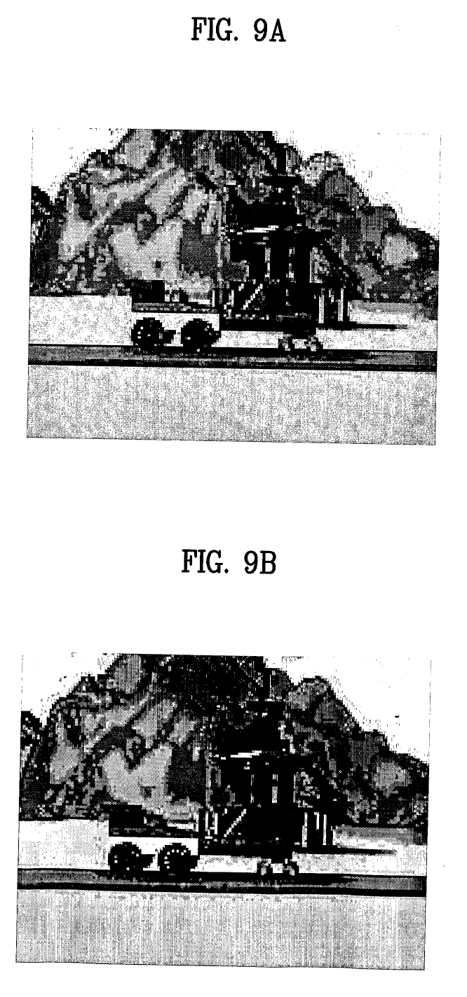

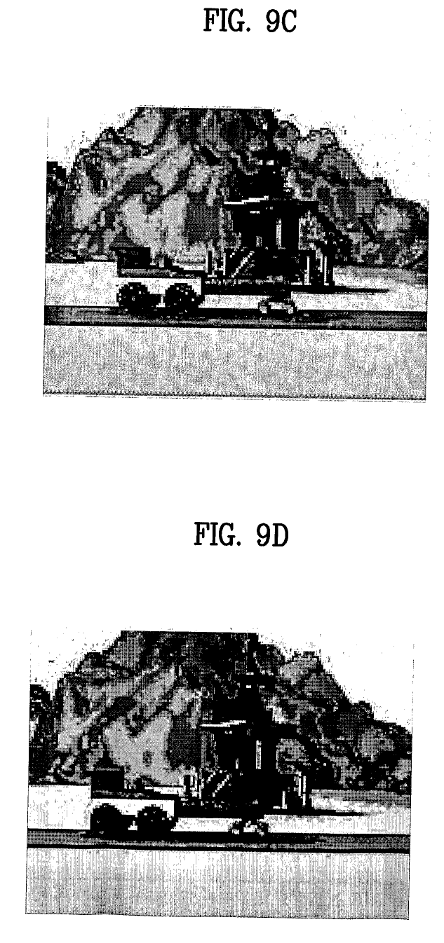

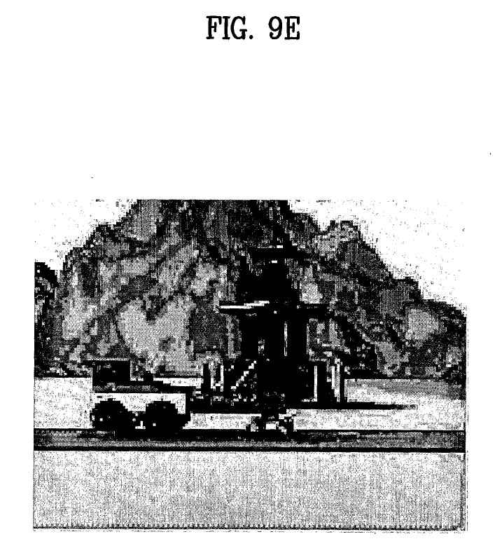

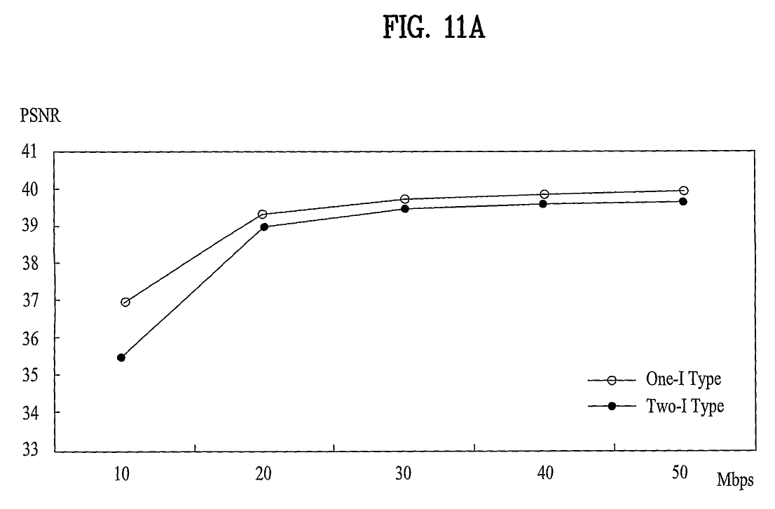

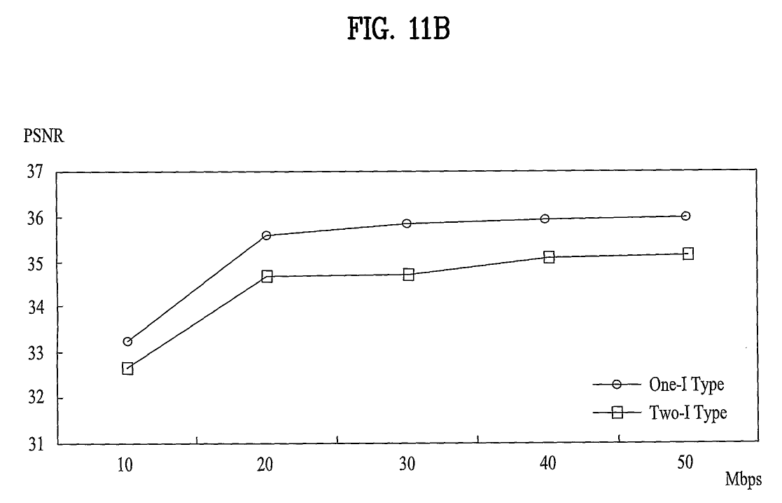

FIG. 11A and FIG. 11B are graphs for explaining a coding result at various bit rates of a sequence in FIG. 9A, in which a small baseline case and a big baseline case are shown.

Referring to FIG. 11A and FIG. 11B, ‘One-I’ type is superior in efficiency in aspect of PSNR for a multiview sequence having a small baseline. ‘Two-I’ type is superior to ‘One-I’ type in performance in aspect of PSNR for a multiview sequence having a big baseline.

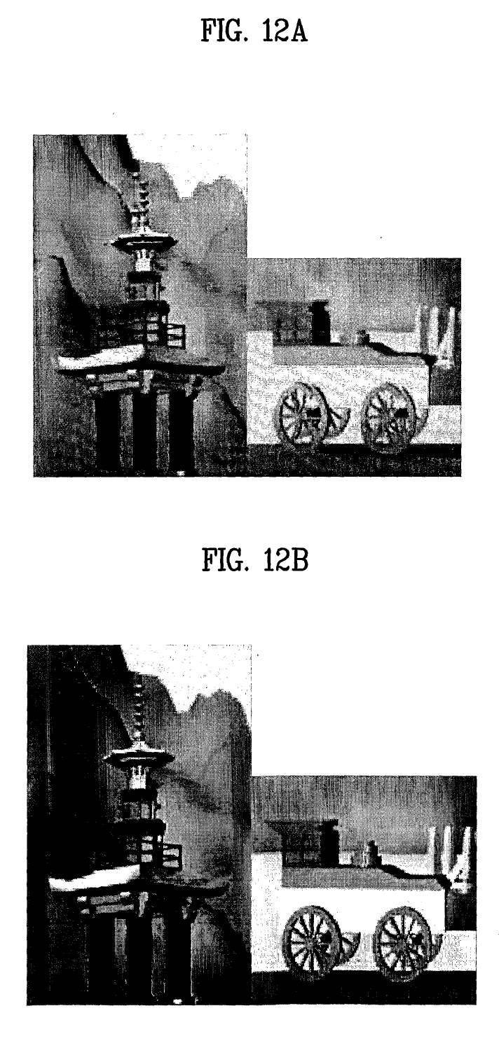

FIG. 12A and FIG. 12B are exemplary diagrams of image comparison in case of coding an image having a big baseline by ‘One-I’ type and ‘Two-I’ type, respectively.

Referring to FIG. 12A and FIG. 12B, in case of a multiview sequence having a big baseline, correlation between views is reduced. To compensate this, ‘I’ frame is increased. And, it is confirmed that the ‘Two-I’ type increasing the ‘I’ frame to compensate such a reduced correlation has better efficiency. Hence, the ‘GGOP’ structure of the present invention has fluidity according to a size of the baseline for the multiview sequence.

Meanwhile, in the ‘GGOP’ structure of the present invention, ‘B_{t,s}’ picture selects a vector having a small predictive error from a variance vector and a motion vector or uses an average total of the two vectors. In case of a multiview sequence having a big motion, the variance vector is selected only because error can be more reduced in variance vector restoration rather than motion vector restoration. On the other hand, if correlation is lowered on a time axis, the motion vector is selected because prediction using the motion vector is more efficient.

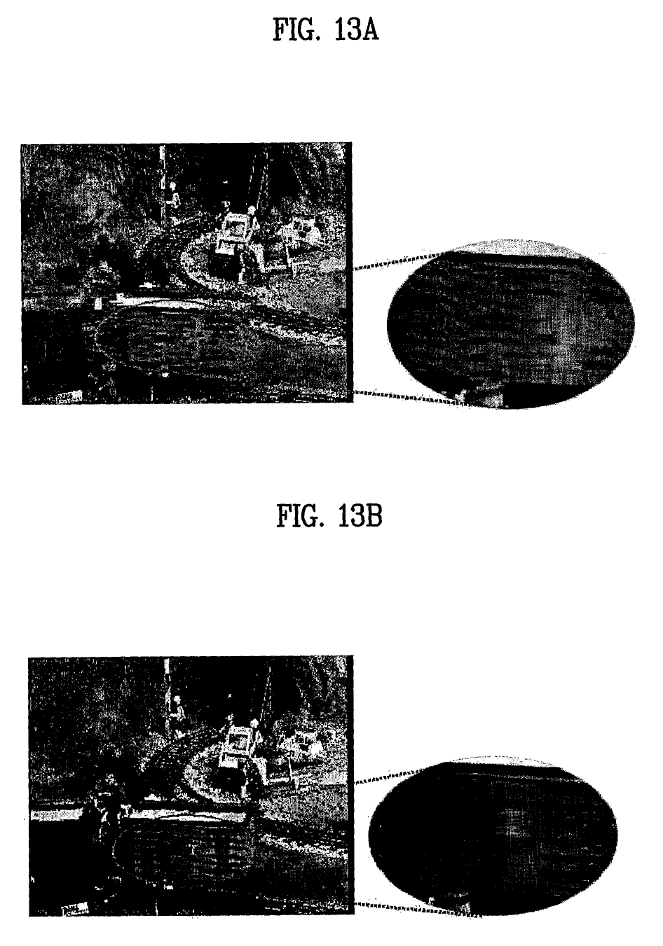

FIG. 13A and FIG. 13B are diagrams of result images for explaining performance of a B_{t,s} frame of the present invention. FIG. 13A shows a result image in case of performing encoding independently by regarding a multiview sequence as an MPEG-2 sequence. And, FIG. 13B shows a result image in case of performing decoding according to the present invention.

Referring to FIG. 13A, since the conventional MPEG-2 cannot predict an area having a big motion using a variance vector, considerable errors occur in the conventional MPEG-2. Yet, the present invention can predict an area having a big motion using a variance vector, thereby reducing errors.

In the present invention, once a transmitting end transmits a main bit stream and an auxiliary bit stream to a receiving end, the receiving end can restore a specific view only.

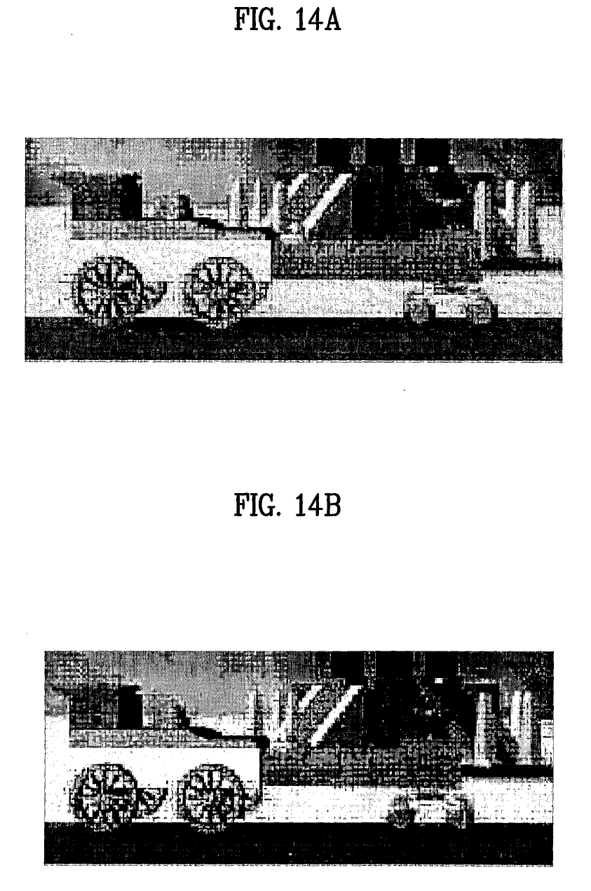

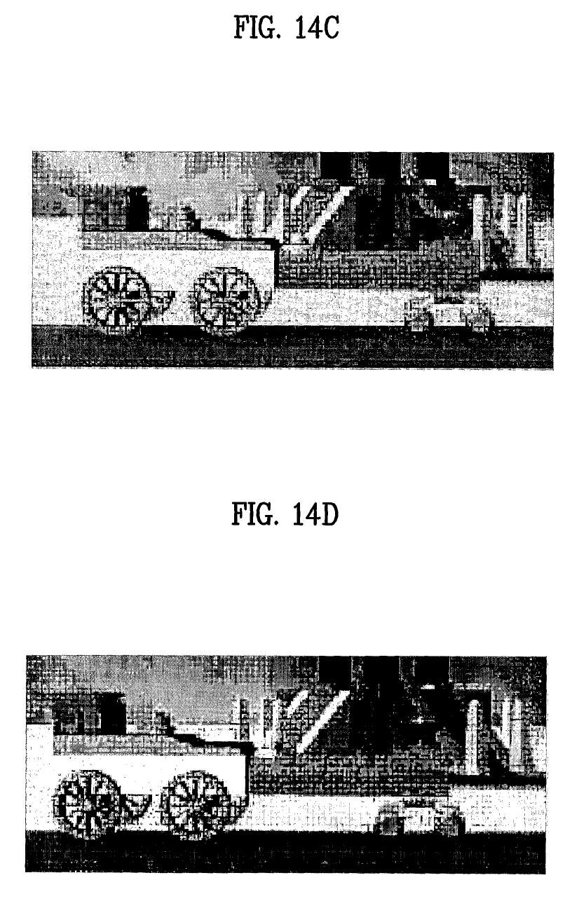

FIGS. 14A to 14D are diagram of result images if second and fourth views are selected by a user having received a 5-view bit stream in FIGS. 9A to 9E in case of a 3-dimensional monitor, which can display a stereo sequence only, is provided to a receiving end.

Namely, FIG. 14A and FIG. 14B show result images acquired using an MPEG-2 decoder and FIG. 14C and FIG. 14D show result images through decoding using a decoding method according to the present invention.

As shown in the drawings, images shown in FIG. 14C and FIG. 14D are clearer than the others. The images shown in FIG. 14A and FIG. 14B result from restoration using variance vectors only and the images shown in FIG. 14C and FIG. 14D include ‘B_{t,s}’ pictures. Hence, in case that a motion or variance vector is big, it is able to reduce predictive errors.

### INDUSTRIAL APPLICABILITY

Accordingly, the present invention encodes the multiview sequence efficiently and decodes a specific view only in the receiving end, thereby performing the encoding/decoding more fluently and efficiently.

And, the present invention is applicable to various fields employing the 3-dimensional image processing technology such as communications, broadcasting, virtual reality, education, medical cares, entertainment and the like.

Moreover, the method of the present invention is implemented into a program to be stored in a record medium (CD-ROM, RAM, ROM, floppy disc, hard disc, photomagnetic disc, etc.) readable by a computer.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A multiview sequence coding method, which generates a bit stream by encoding a plurality of pictures acquired from a plurality of views, wherein the bit stream includes view information for each of a plurality of the pictures and wherein the view information is information designating that the corresponding picture corresponds to which view among a plurality of the views.

2. A multiview sequence coding method comprising the steps of:
generating a main bit stream by encoding pictures of a first picture type for a main view; and
generating an auxiliary bit stream for at least one or more auxiliary views wherein the auxiliary bit stream is generated by encoding pictures of a second picture type predicted using the pictures of the first picture type,
wherein the auxiliary bit stream includes view information for each of the pictures of the second picture type and wherein the view information is information designating that the corresponding picture of the second picture type corresponds to which auxiliary view among the at least one or more auxiliary views.

3. The multiview sequence coding method of claim 2, wherein the view information is inserted in each picture header within the auxiliary bit stream.

4. The multiview sequence coding method of claim 2, wherein the picture of the first picture type comprises an intra picture (I picture), a predictive picture (Pₜ picture) according to a mono-directional motion estimation from the intra picture (I picture), and a predictive picture (Bₜ picture) according to bi-directional motion estimation from the intra picture (I picture) and/or the predictive picture (Pₜ picture).

5. The multiview sequence coding method of claim 4, wherein the picture of the second picture type comprises predictive pictures (Pₛ, Bₛ) according to variance estimation from the picture of the first picture type and predictive pictures (B_{t,s}) according to motions estimation and variance estimation from the first picture type and the predicted pictures (Pₛ, Bₛ).

6. The multiview sequence coding method of claim 5, wherein the auxiliary bit stream configures one stream and wherein the auxiliary bit stream comprises a combination of the entire predictive pictures (Pₛ, Bₛ, B_{t,s}) of the second picture type associated with a plurality of the auxiliary views.

7. The multiview sequence coding method of claim 2, wherein at least one specific view sequence is designated as a main view in an inputted multiview sequence and wherein the rest of the view sequence is designated as an auxiliary view.

8. The multiview sequence coding method of claim 7, wherein the main bit streams are generated in a manner that a number of the main bit streams corresponds to a number of the main views.

9. The multiview sequence coding method of claim 7, wherein a number of the main views depends on an extent of a baseline of the multiview sequence.

10. The multiview sequence coding method of claim 7, wherein a sequence associated with each view is a sequence acquired from each separate sequence capturing equipment (e.g., camera).

11. The multiview sequence coding method of claim 7, a sequence associated with each view is a sequence acquired according to a photographing angle of a sequence capturing equipment (e.g., camera).

12. A multiview sequence decoding method comprising the steps of:
receiving a main bit stream generated by encoding pictures acquired from a plurality of views, respectively;
checking view information designating that a specific picture corresponds to which one of a plurality of the views; and
decoding the picture associated with the specific view in a display according to the checked view information.

13. A multiview sequence decoding method comprising the steps of:
receiving a main bit stream generated by encoding pictures acquired from a main view and an auxiliary bit stream generated by encoding pictures acquired from a plurality of auxiliary views;
restoring the pictures within the main bit stream; and
selectively performing predictive restoration on the picture associated with a specific auxiliary view in a display by utilizing the restored pictures within the main bit stream according to view information existing within the auxiliary bit stream.

14. The multiview sequence decoding method of claim 13, wherein the view information is information designating that a specific picture corresponds to which one of a plurality of the auxiliary views.

15. The multiview sequence coding method of claim 14, wherein the view information is included within each picture header information.

16. A multiview sequence decoding apparatus comprising:
a main bit stream decoding unit receiving a main bit stream generated by encoding pictures acquired from a main view to restore the pictures within the main bit stream; and
an auxiliary bit stream decoding unit receiving an auxiliary bit stream generated by encoding pictures acquired from a plurality of auxiliary views, the auxiliary bit stream decoding unit selectively performing predictive restoration on the pictures of a specific auxiliary view by utilizing the restored pictures within the main bit stream according to view information existing within the auxiliary bit stream.

17. The multiview sequence decoding apparatus of claim 16, wherein the view information is information designating that a specific picture corresponds to which one of a plurality of the auxiliary views.

18. The multiview sequence decoding apparatus of claim 17, wherein the view information is included within each picture header information.

19. A multiview sequence display method, which includes a first display mode displaying pictures corresponding to a main view and a second display mode displaying the pictures corresponding to the main view and pictures corresponding to at least one or more auxiliary views together, wherein either the first display mode or the second display mode is selected according to view information existing within a bit stream including the pictures.

20. The multiview sequence display method of claim 19, wherein the view information is information designating that a specific picture corresponds to which one of a plurality of the views.
